(19) United States
(12) Patent Application Publication
(10) Pub. No.: US 2025/0379664 A1
(43) Pub. Date: Dec. 11, 2025

(54) METHOD FOR DETERMINING INFORMATION INDICATING A RF TRANSMIT POWER ASSOCIATED WITH A RF TRANSMITTER AND SEMICONDUCTOR DEVICE

(71) Applicant: Infineon Technologies AG, Neubiberg (DE)

(72) Inventors: Alexander Michael MELZER, Alberndorf in der Riedmark (AT); Gunther KRAUT, Egmating (DE)

(21) Appl. No.: 19/219,013

(22) Filed: May 27, 2025

(30) Foreign Application Priority Data
Jun. 5, 2024 (DE) 102024205161.6

(51) Int. Cl. H04B 17/10; H04B 1/04

(52) U.S. Cl. CPC H04B 17/102; H04B 1/0458

(57) ABSTRACT

A method includes controlling an RF transmitter to generate a set of RF signals, each RF signal having a frequency value from a set of frequency values, transferring each RF signal to an input port of a directional coupler, the direction coupler including the input port, an output port, a forward port, and a reverse port, wherein the directional coupler is configured to couple to the forward port a first portion of a signal received at the input port, and couple to the reverse port a second portion of a signal received the output port, determining, for each RF signal, measurement information indicating a signal power measured at the reverse port and/or a signal power measured at the forward port to generate a set of measurement values, and determining information indicating an RF transmit power associated with the RF transmitter based on the set of measurement values.

### CROSS-REFERENCE TO RELATED APPLICATION

This application claims priority to Germany Patent Application No. 102024205161.6 filed on Jun. 5, 2024, the content of which is incorporated by reference herein in its entirety.

### TECHNICAL FIELD

The present disclosure relates to determining information indicating a transmit power associated with an RF transmitter.

### BACKGROUND

In the field of automotive radar, mobile communication and other wireless applications, one or more transmit (TX) channels are typically used for transmitting RF signals. Typically microwave monolithic integrated circuits (MMIC) are used which may in addition to the TX channels implement also one or more receive (RX) channels. For many applications such as automotive radar, the output power of each TX channel is a key parameter for the performance. Typically, such parameters are measured and calibrated during production test and then monitored during runtime in the field. It would be beneficial to have a concept that allows the determining of information indicating a transmit power in a cost-effective manner and with high precision. Furthermore, it would be beneficial to have a concept that allows the determining of information indicating a transmit power with high accuracy also during runtime in the field with high precision.

### SUMMARY

According to an aspect, a method for determining information indicating a radio frequency (RF) transmit power associated with a RF transmitter includes controlling the RF transmitter to generate a set of RF signals, each RF signal having a frequency value from a set of frequency values and transferring each RF signal of the set of RF signals to an input port of a directional coupler. The direction coupler includes in addition to the input port, an output port, a forward port and a reverse port, wherein the directional coupler is configured to couple to the forward port a first portion of a signal received at the input port and wherein the directional coupler is configured to couple to the reverse port a second portion of a signal received at the output port. The method further includes determining, for each RF signal of the set of RF signals transferred to the directional coupler, measurement information indicating at least one of a signal power measured at the reverse port or a signal power measured at the forward port to generate a set of measurement values and determining information indicating the transmit power based on the set of measurement values.

According to a further aspect, a semiconductor device includes a semiconductor chip, the semiconductor chip including at least one RF transmitter; a directional coupler coupled to the RF transmitter, wherein the directional coupler includes an input port to receive an RF signal from the RF transmitter. The directional coupler further includes an output port, a forward port and a reverse port, wherein the directional coupler is configured to couple to the forward port a first portion of a signal transmitting from the input port to the output port and wherein the directional coupler is configured to couple to the reverse port a second portion of a signal transmitting from the output port to the input port. A controller is configured to control the RF transmitter to generate a set of RF signals, each RF signal having a frequency value from a set of frequency values and a detector is configured to determine, for each RF signal of the set of RF signals transferred to the directional coupler, first measurement information indicating at least one of a signal power measured at the reverse port or a signal power measured at the forward port to generate a set of measurement values and to determine a transmit power of the RF transmitter based on the set of measurement values.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 illustrates a schematic circuit diagram of a RF transmitter.

FIG. 2 illustrates a schematic circuit diagram of a RF transmitter according to an example.

FIG. 3 illustrates a directional coupler according to an example.

FIGS. 4A and 4B show simulations according to examples.

FIG. 5 shows simulations according to an example.

FIG. 6 shows a diagram illustrating a method according to an example.

### DETAILED DESCRIPTION

The examples described herein provide a new concept for determining information indicating an RF transmit power (herein also referred to as transmit power information or transmit power).

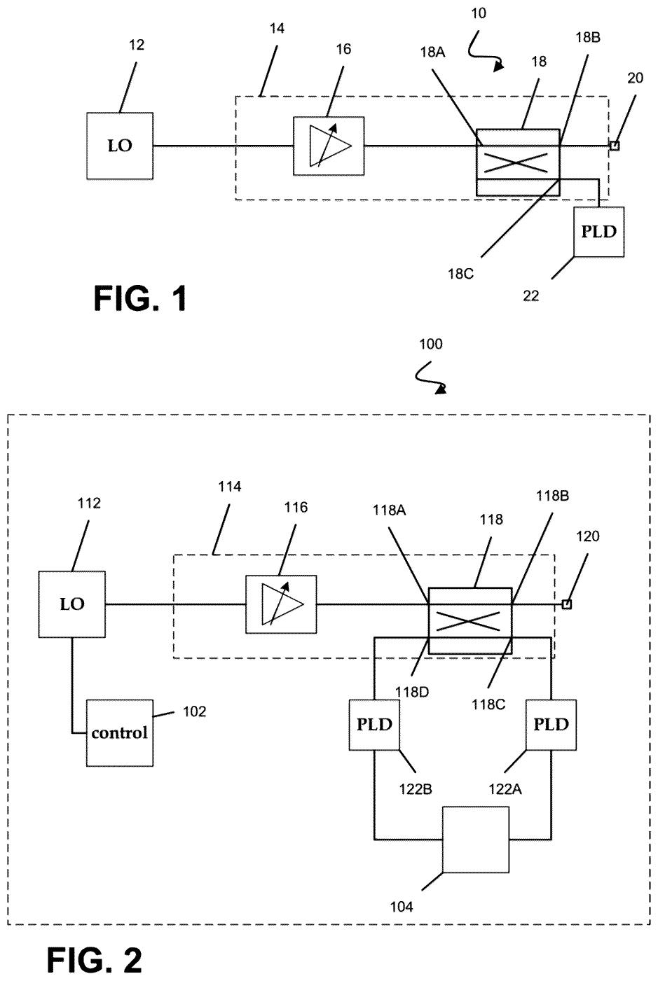

Semiconductor devices implemented as monolithic microwave integrated circuits (MMICs) typically utilize a directional coupler in order to measure transmit power during a production test or during runtime. FIG. 1 shows an example of a RF transmitter 10 which may be implemented in a semiconductor device including a local oscillator (LO) 12 coupled to a RF transmitter 14. The RF transmitter 14 includes a power amplifier 16 and a directional coupler 18 coupled at an input port 18A to a power amplifier 16. The power amplifier receives a version of an LO signal generated by the local oscillator 12 and amplifies the LO signal to generate an RF transmit signal. An output port 18B of the directional coupler 18 is coupled to an output structure 20 (pad, solder ball etc.) of the RF transmitter 12. A forward port 18C of the directional coupler 18 is coupled to a power level detector (PLD) 22. The power level detector 22 receives a portion of the RF transmit signal in order to determine transmit power information.

Measuring the transmit power using the RF transmitter 10 shown in FIG. 1 is however sensitive to mismatches at the output 20 of the RF transmitter in case the directional coupler 18 has a non-ideal directivity. For example, when using the RF transmitter 10 during production testing for measuring and calibrating the RF transmit power, the output structure is typically not connected or unmatched such that a portion of the RF transmit signal is reflected back to the output port 18B of the directional coupler 18. In view of this, a portion of the RF transmit signal (reflected RF signal) is reflected at the output 20 back to the output port 18B of the directional coupler 18. For a non-ideal directional coupler 18, a portion of the reflected RF signal leaks into the forward port 18C of the directional coupler 18 which introduces an error in the measurement of the transmit power information by the power level detector 22 as will be explained further below.

In the following a new concept for determining RF transmit power information will be described which allows determining (e.g., estimating) RF transmit power information in a more accurate manner for non-ideal directional couplers under unmatched conditions. The described concept can be used with standard components that are implemented in a semiconductor device (MMIC) and allows RF transmit power measurements without making use of specific external test equipment. The concept can be used during production testing as well as during runtime in the field, for example for testing, monitoring or calibration.

The new concept is based on determining (e.g., detecting, measuring, estimating etc.) information indicating a signal power (e.g., signal power or signal voltage) at a forward port of a directional coupler and/or at a reverse port of the directional coupler for RF transmit signals at different frequencies. As will be described later, this allows to determine the transmit power information independent from any reflections occurring at reflecting structures (e.g., mismatches, non-connected pads or balls, or other reflecting structures) and independent of a directivity of the directional coupler. With the new concept, non-ideal directional couplers can be used allowing reducing manufacturing costs without compromising accuracy of the transmit power measurement.

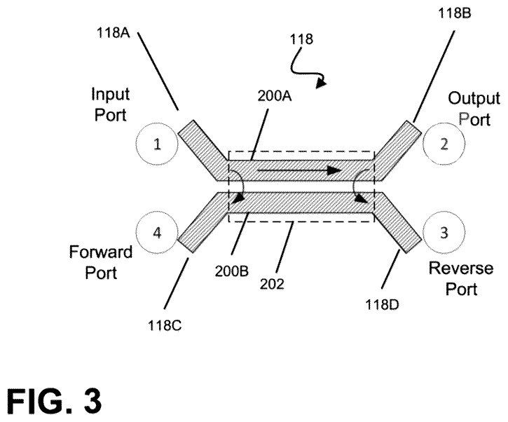

With reference to FIG. 2, an example of a semiconductor chip 100 implementing this concept will be described. The semiconductor chip 100 which may be according to one example a MMIC semiconductor chip including an RF transmitter 114. The semiconductor chip 100 may include optionally in addition to the RF transmitter 114 an RF receiver (not shown). The RF transmitter 114 may for example be a radar transmitter such as a frequency modulated continuous wave (FMCW) transmitter or any other wireless RF transmitter. The term radio frequency (RF) as used herein is intended to cover frequencies of more than 1 GHz and up to 200 or more GHz. As such it includes several radar or wireless frequency bands such as the ISM band, UWB band, automotive Long Range Radar band and automotive short range Radar band.

The semiconductor chip 100 includes a local oscillator (LO) 112 coupled to the RF transmitter 114. The RF transmitter 114 includes a power amplifier 116 and a directional coupler 118 having an input port 118A coupled to an output of the power amplifier 116. While FIG. 2 shows one transmit channel, it is to be understood that the RF transmitter 114 may include in other examples more than one transmit channels with each transmit channel having a power amplifier and a directional coupler. The power amplifier 116 receives a version of LO signals generated by the local oscillator 112 and amplifies the LO signals to generate RF transmit signals. The RF transmit signals are received at the input port 118A of the directional coupler 118. A main portion of each RF transmit signal is transferred to an output port 118B of the directional coupler 118 and a smaller portion of the RF transmit signal is coupled to a forward port 118C. The output port 118B of the directional coupler 118 is coupled to an output structure 120 (pad, solder ball, launcher etc.) of the RF transmitter 114. The directional coupler 118 further includes a reverse port 118D which receives a portion of the RF signals reflected back to the output 118B. The forward port 118C of the directional coupler 118 is coupled to a first power level detector (PLD) 122A. The reverse port 118D of the directional coupler 118 is coupled to a second power level detector (PLD) 122B. The first power level detector 122A and the second power level detector 122B are coupled to a processor 104. The processor 104 receives a set of measurement information (e.g., a set of measurement values) from the first power level detector 122A and the second power level detector 122B and calculates power transmit information based on the received measurement information. As will be described in more detail below, in one example the processor 104 is configured to calculate an average of the set of measurement and combined the average result with one or more coupling coefficients (e.g., forward coupling coefficient, directivity, isolation coefficient) of the directional coupler 118. The first and second power level detectors 112A,122B form together with the processor 104 a detector (e.g., a detector circuit).

The local oscillator 112 is controlled by a controller 102 to generate a set of LO signals with each LO signal having a frequency from a set of frequencies such that different LO signals of the set of LO signals have different frequency values distributed in frequency range.

The power amplifier 116 amplifies the set of LO signals to obtain a set of RF signals. The set of LO signals and the set of RF signals may for example include a set of discrete continuous wave signals where each discrete continuous wave signal has a single frequency selected from the set of frequencies. The set of RF signals may however in other examples include signal portions or instants of a frequency modulated continuous wave signal at different time instants. The frequency modulated continuous wave signal may change continuously the frequency such the at respective time instants each signal portion has a different frequency. Accordingly, the set of RF signals may in one example include signal portions of a frequency modulated continuous wave signal undergoing a continuous change of the frequency.

Each respective measurement at the forward port 118C and/or the reverse port 118D is therefore taken at a different frequency of the RF transmit signal resulting in one or more sets of measurements values indicating the signal power received at the forward port 118C and/or reverse port 118D for the respective frequency. The power measurements at the forward port 118C and at the reverse port 118D taken at different RF transmit frequencies allow an accurate determining of the RF transmit power as will be explained in more detail below independent of the occurrence of reflections.

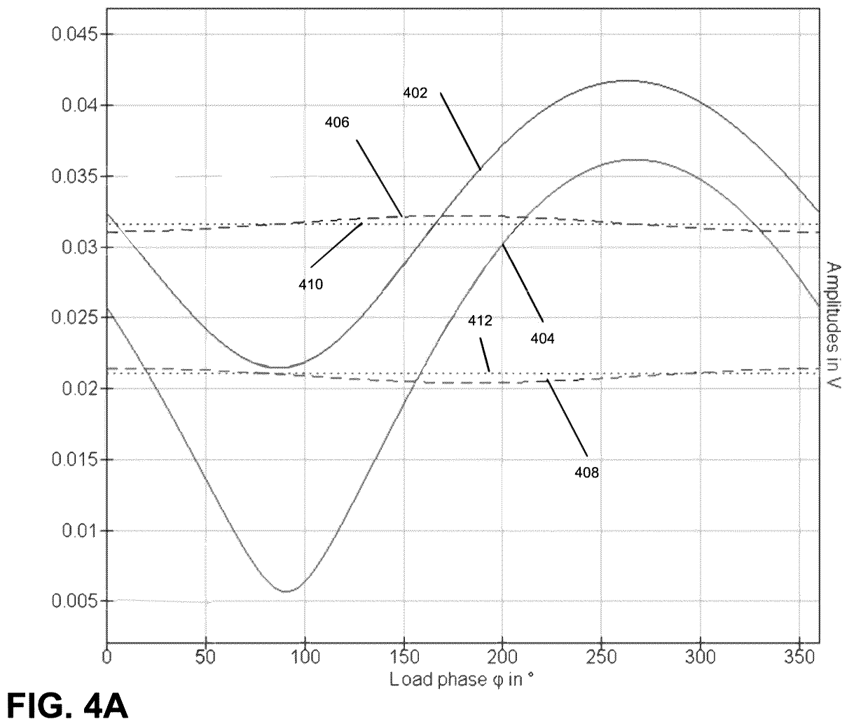

For better understanding, detailed considerations and calculations will now be presented with reference to an example directional coupler 118 shown in FIG. 3.

The directional coupler 118 shown in FIG. 3 may for example include planar transmission lines (backward coupler) with the input port 118A referenced as port 1, output port 118B referenced as port 2, the forward port 118C referenced as port 4 and the reverse port 118D referenced as port 3. The forward port 118C is sometimes referred to as a coupled port and the reverse port is sometimes referred to as an isolating port. The directional coupler 118 is a symmetric directional coupler comprising a main line 200A and a coupled line 200B. The main line 200A and the coupled line 200B are parallel in a coupling section 202 which in this example has a length of λ/4 or close to λ/4 with λ being the wavelength of the RF signals. It is however understood that FIG. 3 is only one of many implementation examples for a directional coupler. Many other concepts and structures exist for symmetrical directional couplers which can be used in examples described herein.

The directional coupler 118 can be described using a S-parameter matrix (S_{m,n}) with 1≤m, n≤4, see equation (1) below.

$$S = ( \begin{matrix}{S}_{11} & {S}_{12} & {S}_{24} & {S}_{14} \\ {S}_{12} & {S}_{11} & {S}_{14} & {S}_{24} \\ {S}_{24} & {S}_{14} & {S}_{11} & {S}_{12} \\ {S}_{14} & {S}_{24} & {S}_{12} & {S}_{11}\end{matrix} ) \qquad ( 1 )$$

Note that the S-parameter matrix is established exploiting symmetry, reciprocity and conservation of energy considerations of the directional coupler 118.

Using for incoming RF signals (incoming waves) at the ports 1 to 4 the signal vector a=(aₙ)^{T} and for outgoing RF signals (outgoing waves) at the ports 1 to 4 the signal vector b=(bₙ)^{T}, the outgoing RF signals at the ports 1 to 4 can be described by b=S a. Furthermore, port 3 and port 4 are assumed to be well matched which allows to set a3 and a4 of the vector a to zero, a₃=a₄=0.

In the following, a reflection at a reflecting structure (hereinafter also referred as load) connected to the output port 118B is assumed which reflects a portion of the RF output signal as a reflection signal back to the output port 118B. The reflecting structure may in one example be the output structure 120, for example when the output structure 120 is unsoldered or unconnected or other reflecting structures implemented in package of the semiconductor chip 100 or an antenna feed.

A load having a complex reflection coefficient Γ is introduced for addressing the reflection by the reflecting structure and the incoming and outgoing RF signals at port 2 can be described by a₂=Γb₂.

Inserting the above relation into equation (1) results in

$$b = \frac{1}{1 - {S}_{11} Γ} ( \begin{matrix}( {S}_{12}^{2} - {S}_{11}^{2} ) {a}_{1} Γ + {S}_{11} {a}_{1} \\ {S}_{12} {a}_{1} \\ ( {S}_{12} {S}_{14} - {S}_{11} {S}_{14} ) {a}_{1} Γ + {S}_{24} {a}_{1} \\ ( {S}_{12} {S}_{24} - {S}_{11} {S}_{14} ) {a}_{1} Γ + {S}_{14} {a}_{1}\end{matrix} ) \qquad ( 2 )$$

Assuming for the directional coupler 118 that reflections back to the input port 118A (port 1) are small, S₁₁<<1, and the vast majority of the input RF signal received at the input port 118A is transferred to the output port 118B, S₁₂≈1, equation (2) is reduced to the following set of equations:

$$\begin{matrix}{b}_{1} = {a}_{1} Γ + {S}_{11} {a}_{1} , \\ {b}_{2} = {S}_{12} {a}_{1} , \\ {b}_{3} = {s}_{14} {a}_{1} Γ + {S}_{24} {a}_{1} , \\ {b}_{4} = {S}_{24} {a}_{1} Γ + {S}_{14} {a}_{1} .\end{matrix} \qquad ( 3 )$$

Note that each of the coefficients b_{1, . . . n} has a complex value (complex number) representing amplitude and phase of the respective outgoing signals at ports 1 to n. Considering only the equations for b₃ and b₄, the complex voltage amplitudes appearing at port 3 (reverse) and port 4 (forward), Uᵣₑᵥ and U_{fwd}, are obtained after renaming b₄=U_{fwd}, b₃=Uᵣₑᵥ, a₁=U_{src} with U_{src} representing the complex voltage amplitude (source amplitude) of the incoming RF signal at the input port 118A (port 1),

$${U}_{rev} = {U}_{src} ( {S}_{14} Γ + {S}_{24} ) , \qquad ( 4 )$$

$${U}_{fwd} = {U}_{src} ( {S}_{24} Γ + {S}_{14} )$$

For a backward coupler with electrical length λ/4 using microstrips, it can be shown that arg(S₁₄)≈0° in the frequency range of interest and arg(S₂₄) 180°. Note that arg(x) is the angle between the real axis and the line connecting x to the origin when the complex value x is represented in a complex plane. Accordingly, the complex value S₁₄ can be replaced by the real value |S₁₄| and the complex value S₂₄ S can be replaced by the real value −|S₁₄|. Defining the forward coupling factor k=|S₁₄|, the isolation coupling factor i=|S₂₄| and the directivity d=k/i, we obtain

$${U}_{rev} = {U}_{src} ( k Γ - k / d ) , \qquad ( 5 )$$

$${U}_{fwd} = {U}_{src} ( k - k Γ / d )$$

Note that the S-parameters and therefore the forward coupling factor, isolation coupling factor and directivity are predetermined coupling coefficients for a specific coupler design and can be derived for each directional coupler 118.

For a perfect coupler (d→∞), power level measurements at the forward port 118C and reverse port 118D allow obtaining the amplitude of the complex values U_{fwd}=U_{src}k at the forward port 118C and Uᵣₑᵥ, =U_{src}kΓ at the reverse port 118D. From the measurement at the forward port 118C, the amplitude and power of the RF signal incoming at the input port 118A can be determined using the relation U_{fwd}=U_{src}k.

However, as can be seen from the above equations, the amplitude of the outgoing waves at the forward port 118C and reverse port 118D are influenced by the unknown reflection of the RF output signal at the reflecting structure as both Uᵣₑᵥ and U_{fwd} are dependent on the complex reflection coefficient Γ when the directional coupler 118 is a non-ideal directional coupler.

A corrected complex amplitude U_{fwd,corr}=U_{src}k can be defined and the complex reflection coefficient Γ can be eliminated from the above equations to obtain

$${U}_{rev , corr} = \frac{{U}_{rev} {d}^{2} + {U}_{fwd} d}{{d}^{2} - 1} , \qquad ( 6 )$$

$${U}_{fwd , corr} = \frac{{U}_{fwd} {d}^{2} + {U}_{rev} d}{{d}^{2} - 1}$$

It is to be noted that U_{fwd} and Uᵣₑᵥ are complex values and therefore the corrected U_{rev,corr} and U_{fwd,corr} are also complex.

Calculating the corrected amplitudes using equation 6 requires knowledge of the complex values U_{fwd} and Uᵣₑᵥ. A measurement capable of determining phases and amplitudes at the forward port 118C and reverse port 118D may allow to determine these information, however at the cost of expensive equipment.

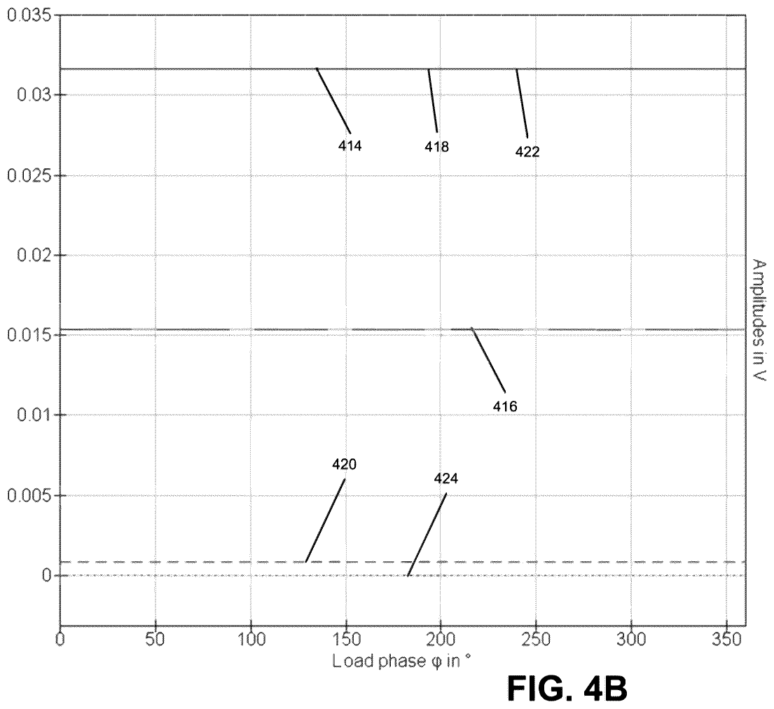

FIGS. 4A and 4B show simulations of a 20 dB coupler configured for a frequency band from 76 GHz to 81 GHz and operated at 0 dBm input power in the center of the frequency band to verify the above. The coupler is configured to have a directivity d=6.3 dB at the center frequency.

FIG. 4A shows the absolute value of the complex amplitude for a voltage standing wave ratio (VSWR) of 5:1 which is equal to an absolute value of the complex reflection coefficient Γ of 2/3. In FIG. 4A the absolute value of the complex amplitude is shown as a function of the load phase which is the phase of the complex load at the output port 118B. Note that the absolute value of the complex amplitude corresponds to the information that is measured by the power level detectors 122A and 122B described with respect to FIG. 2. Curve 402 shows the absolute value |U_{fwd}| of the amplitude at the forward port 118C and curve 404 shows the absolute value |Uᵣₑᵥ| of the amplitude at the reverse port 118D. It can be observed that a significant fluctuation of the absolute values at the forward port 118C and reverse port 118D occurs. A measurement of the signal power using the power level detectors 122A and 122B therefore contains an error. Curve 406 (dashed line) shows the absolute value |U_{fwd,corr}| of the corrected amplitude at the forward port 118C and curve 408 (dashed line) shows the absolute value |U_{rev,corr}| of the corrected amplitude at the reverse port 118D. For comparison the true value obtained for a directional coupler with perfect directivity obtained for an ideal coupler with perfect directivity (d→∞) for the forward port 118C is shown as dotted line 410 and the true value obtained for an ideal coupler with perfect directivity (d→∞) for the reverse port 180D is shown as dotted line 412.

FIG. 4B shows the absolute value of the complex amplitude for a voltage standing wave ratio (VSWR) of 1:1 which is equal to an absolute value of the complex reflection coefficient Γ of 0 (no reflection). Curve 414 shows the absolute value |U_{fwd}| of the amplitude at the forward port 118C versus the load phase and curve 416 shows the absolute value |Uᵣₑᵥ| of the amplitude at the reverse port 118D versus the load phase. Curve 418 (dashed line) shows the absolute value |U_{fwd,corr}| of the corrected amplitude at the forward port 118C and curve 420 (dashed line) shows the absolute value |U_{rev,corr}| of the corrected amplitude at the reverse port 118D calculated according to equation 6. For comparison, the true value for the forward port 118C is shown as line 422 and the true value for the reverse port 118D is shown as line 424. The true value for the reverse port 118D is zero as expected for a non-reflecting load. Note that the curves 414, 418 and 422 are overlying each other as the corrected value calculated from equation 6 and the absolute value |U_{fwd}| of the measured amplitude at the forward port are identical to or insignificant different from the true result. As can be seen, no fluctuation of the absolute values at the forward port 118C and reverse port 118D occurs. It can be noted that there is no coupling to the forward port 118C from a reflected wave due to the absence of a reflected wave for Γ being 0 which makes the measurement at the forward port 118C only dependent on the forward coupling factor k and the incoming RF signal as it is expected for a perfect directional coupler. It can further be observed that the uncorrected measured values |Uᵣₑᵥ| represented by line 416 deviates from the true value represented by line 424 in view of the non-ideal directional coupler 118 which results in a coupling of a portion of the incoming RF signal to the reverse port 118D. This deviation can be corrected to a much lower value by using the above described equation 6 as can be observed from curve 420 representing the corrected amplitude value |U_{rev,corr}|.

Accordingly, for both simulations shown in FIGS. 4A and. 4B the corrected values |U_{fwd,corr}| and |U_{rev,corr}| deviate only marginal from the true value which allows determining the transmit power information by amplitude and phase measurements at the forward port 118C and reverse port 118D using equation 6.

In the RF transmitter 114 shown in FIG. 2, the signals of the outgoing RF signals are measured at the forward port 118C and the reverse port 118D with power level detectors 122A and 122B. Power level detectors are typically used in MMICs to cope with high frequencies and allow a cost-effective power or amplitude measurement. Power level detectors may include diodes, transistors, bolometers etc. Power level detectors, however, are capable of measuring only the absolute value of the amplitude or the absolute value of the power. They are however not capable of measuring a phase.

In order to obtain corrected amplitudes when only power levels are measured at the reverse port 118D and forward port 118C, the complex amplitudes in equation 5 as well as the reflection coefficient are substituted by their polar representations U_{fwd}=A_{fwd}e^{jα}, Uᵣₑᵥ=Aᵣₑᵥe^{jβ}, Γ=re^{jφ} using real values for the amplitudes A_{fwd}, Aᵣₑᵥ, r and the corresponding phases α, β, γ:

$${A}_{rev} {e}^{j β} = {U}_{src} ( {kre}^{j φ} - k / d ) , \qquad ( 7 )$$

$${A}_{fwd} {e}^{j α} = {U}_{src} ( k - {kre}^{j φ} / d )$$

The power level detectors measure the square of the absolute values (signal power). Computing the square of the absolute values delivers

$${A}_{rev}^{2} = {\vert {U}_{src} \vert}^{2} {k}^{2} ( 1 + {d}^{2} {r}^{2} - 2 dr cos φ ) / {d}^{2} , \qquad ( 8 )$$

$${A}_{fwd}^{2} = {\vert {U}_{src} \vert}^{2} {k}^{2} ( {d}^{2} + {r}^{2} - 2 dr cos φ ) / {d}^{2}$$

To eliminate the unknown load phase φ, an average is calculated over N measurements running γ in N equidistant steps Δφ within [0°, 360° [with N being an even integer equal or greater than 2. This results in

$${A}_{rev , avg}^{2} = {\vert {U}_{src} \vert}^{2} {k}^{2} {\sum }_{n = 1}^{N} [ 1 + {d}^{2} {r}^{2} - 2 dr cos ( ( n - 1 ) Δ φ ) ] / ( {Nd}^{2} ) = {\vert {U}_{src} \vert}^{2} {k}^{2} ( 1 + {d}^{2} {r}^{2} \text{?} \qquad ( 9 )$$

$${A}_{fwd , avg}^{2} = {\vert {U}_{src} \vert}^{2} {k}^{2} {\sum }_{n = 1}^{N} [ {d}^{2} + {r}^{2} - 2 dr cos ( ( n - 1 ) Δ φ ) ] / ( {Nd}^{2} ) = {\vert {U}_{src} \vert}^{2} {k}^{2} ( {d}^{2} + {r}^{2} ) \text{?}$$

$$\text{?} \text{indicates text missing or illegible when filed}$$

taking into account that the sum over the cosines vanishes for even N.

Solving the equations 9 for the two unknowns r and |U_{src}| delivers estimations rest and U_{src,est} (which are real values) of the true reflection coefficient and source voltage from averaged measurements A_{rev,avg} and A_{fwd,avg}:

$${r}_{est} = \sqrt{\frac{{A}_{rev , avg}^{2} {d}^{2} - {A}_{fwd , avg}^{2}}{{A}_{fwd , avg}^{2} {d}^{2} - {A}_{rev , avg}^{2}}} , \qquad ( 10 )$$

$${U}_{src , est} = \frac{d}{k} \sqrt{\frac{{A}_{fwd , avg}^{2} {d}^{2} - {A}_{rev , avg}^{2}}{{d}^{4} - 1}}$$

By considering again the equations A_{fwd,corr}=U_{src,est}k and A_{rev,corr}=U_{src,est}krₑₛₜ, an estimation of the true absolute value of the amplitudes is obtained:

$${A}_{rev , corr} = \sqrt{\frac{( {A}_{rev , avg}^{2} {d}^{2} - {A}_{fwd , avg}^{2} ) {d}^{2}}{{d}^{4} - 1} ,} \qquad ( 11 )$$

$${A}_{fwd , corr} = \sqrt{\frac{( {A}_{fwd , avg}^{2} {d}^{2} - {A}_{rev , avg} \text{?}}{{d}^{4} - 1}}$$

$$\text{?} \text{indicates text missing or illegible when filed}$$

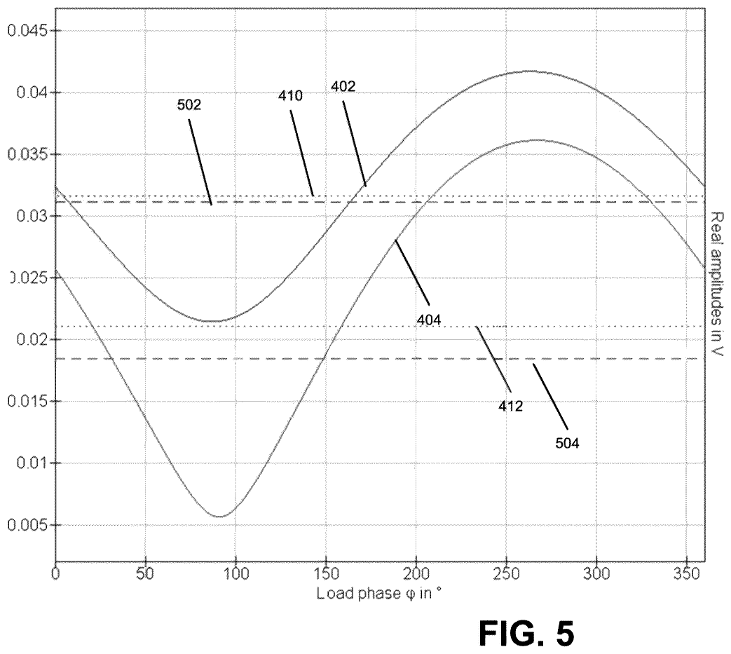

FIG. 5 shows a circuit simulation based on the RF transmitter of FIG. 2 over load phase φ for reflection coefficients r=2/3 (VSWR 5:1). Curves 402 and 404 are the same curves displayed in FIG. 4A showing the varying absolute value |U_{fwd}| of the amplitude at the forward port 118C and the absolute value |Uᵣₑᵥ| of the amplitude at the reverse port 118D, respectively. Furthermore, the curves 410 and 412 are the same curves displayed in FIG. 4A showing the true value obtained for an ideal coupler (d→∞) at the forward port 118C and the true value obtained for an ideal coupler (d→∞) for the reverse port 118D is shown as dotted line 412.

Curve 502 shows the corrected absolute amplitude A_{fwd,corr} calculated using equation 11 and curve 504 shows the corrected absolute amplitude A_{rev,corr} calculated using equation 11.

It can be observed that the reduction from complex amplitudes to absolute amplitudes in combination with the above averaging imposes a slight degradation in the deviation of the corrected amplitudes displayed by curves 502 and 504 compared to the expected amplitudes displayed by curves 410 and 412, when compared to FIG. 4A. For the curve 502 corresponding to the forward port 118C the deviation is still very low, for the curve 504 corresponding to the reverse port 118D the deviation is however higher but still significantly better than the uncorrected measurement. Because in testing the forward wave is of primary interest to ensure a quality of the output power of the transmitted RF signal, the method using power level detectors in combination with equations 9 to 11 can be fully accepted.

In order to determine A_{fwd,corr}, A_{rev,corr}, the values of A_{rev,avg} and A_{fwd,avg} are calculated according to equation 9 which requires to average equidistant samples Aᵣₑᵥ(φ),Afw_{d}(φ) along the interval [0°, 360° [of the load phase φ.

The concept disclosed herein proposes to alter the frequency of the RF transmit signal to generate a set of measurement values in order to obtain a variation of the load phase such that a set of measurement values is obtained at the forward port 118C and/or the reverse port 118D. The set of RF signals may for example be obtained by varying the frequency of the LO signal generated by the Local Oscillator 112 in discrete steps or by continuously changing the frequency (e.g., via a frequency ramp) and selecting specific sampling times for measuring the RF power information at the forward port 118C and the reverse port 118D. The frequencies in the set of RF frequencies are in one example selected to obtain equidistant load phases allowing the simple calculation of the average values as described above. In examples, the frequencies may be generated in an ascending order or a descending order, but in other examples the frequencies of the set of frequencies may be generated in a non-ascending or non-descending manner, for example in a random manner.

To calculate the transmit power information, the processor 104 may be configured to average respective sets of measurement values received from the power level detectors 122A and/or 122B and to determine a first average value and/or a second average value. The transmit power information is calculated by the processor 104 by combining the average values with coupling coefficients of the direction coupler 118 (e.g., directivity) according to equation 11 to obtain the corrected amplitude information A_{fwd,corr} and/or A_{rev,corr}. Using the relation A_{fwd,corr}=U_{src,est}k, the transmit power information U_{src,est} can be calculated.

In order to measure the load phase over the whole range [0°, 360° [, a minimum distance d to the reflecting structure can be calculated. With a bandwidth B defined by the difference between the maximum and minimum frequencies of the set of frequencies, the period Tₚ required to change the load phase from 0 to 360° when the frequency changes from the maximum to the minimum is obtained by

$${T}_{p} = \frac{1}{B} .$$

With the physical distance d the propagation delay for the distance to the reflecting structure and back to the directional coupler 118 results in

$$T = \frac{2 d}{c} .$$

Setting T=Tₚ we get a minimum distance of

$$d = \frac{c}{2 B} .$$

Assuming in one example a 77 GHz radar system with a frequency band of 76-81 GHz the bandwidth is calculated to be B=5 GHz, such that the minimum distance is around d≈15 mm in an MMIC chip substrate with εᵣ=4.

It may however be understood that other ways of determining the transmit power information from the set of measurements may be possible and implemented by the processor 104. For example, the transmit power information may be determined by fitting curves (e.g., curves similar to the curves 402, 404) to the set of measurement values which may allow to determine in addition to the transmit power also other parameters (e.g., reflection coefficient of the reflecting structure). Although this may require more computing power by the processor 104, it may allow to reduce the required phase load to only a portion of the interval [0°, 360° [, for example to [0°, 180° [thereby also reducing the required minimum distance.

Furthermore, empirically established relations may be used to determine the transmit power from the set of measurements. According to an example, the transmit power information can be determined by calculating the corrected the amplitude at the forward port 118C using the relation U_{fwd,corr}(φ)=U_{fwd}(φ)+(Uᵣₑᵥ(φ)−avg(Uᵣₑᵥ(φ)))/d which may result in a sufficient accurate estimation of the transmit power.

It may further be understood that the accuracy of the calculated transmit power information increases with the number of measurements (number of measurement values) which corresponds to the number of frequency values in the set of frequency values.

For determining the transmit power information, it would be ideal to avoid any reflection from the load back to the directional coupler. In some situations, such as during testing, reflections cannot be avoided as a pad or a ball for soldering to a PCB is open (not connected). In such cases, the above concept can be used to still determine the transmit power information. To use the concept in such situations, it is beneficial to have a signal reflection at a single location or to have one signal reflection which is dominant over signal reflections at other locations allowing to neglect the weaker reflections. This specifically holds true in test engineering as there is a defined reflection location due to the open pad or open ball. In view of the above, the described concept is particular useful for test engineering but not limited thereto. For medium to large chips or systems in package, the required minimum distance may be within typical distances to such structures. Furthermore, in the future higher frequencies may be used in RF devices such that the minimum distance may shrink further to lower values.

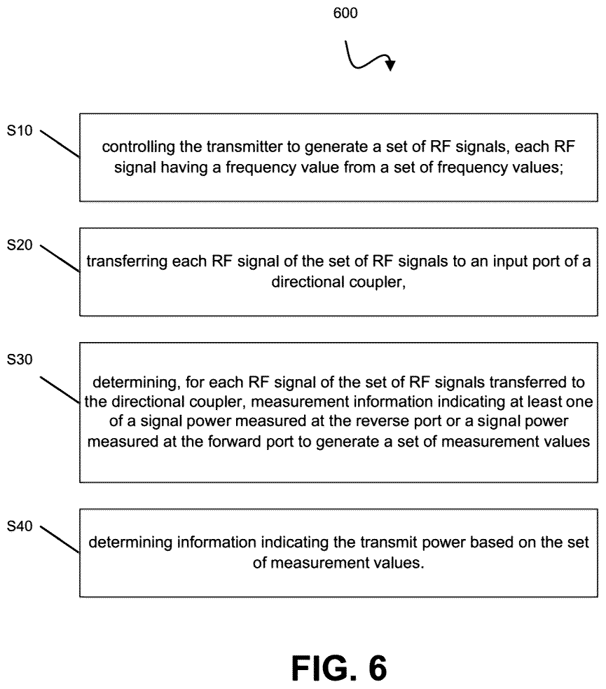

Referring now to FIG. 6, a diagram of implementing a method 600 according to the concept as described above will be described. The method 600 starts with a step S10 of controlling the RF transmitter to generate a set of RF signals, each RF signal having a frequency value from a set of frequency values. At S20, each RF signal of the set of RF signals is transferred to an input port of a directional coupler. For each RF signal of the set of RF signals transferred to the directional coupler, measurement information indicating at least one of a signal power measured at the reverse port or a signal power measured at the forward port to generate a set of measurement values is determined at S30. At S40, information indicating the transmit power based on the set of measurement values is determined.

### Aspects

In addition to the above described aspects, the following aspects are disclosed.

Aspect 1 is a method for determining information indicating an RF transmit power associated with a RF transmitter, the method comprising:
controlling the RF transmitter to generate a set of RF signals, each RF signal having a frequency value from a set of frequency values;
transferring each RF signal of the set of RF signals to an input port of a directional coupler, the direction coupler comprising in addition to the input port, an output port, a forward port and a reverse port, wherein the directional coupler is configured to couple to the forward port a first portion of a signal received at the input port and wherein the directional coupler is configured to couple to the reverse port a second portion of a signal received the output port; determining, for each RF signal of the set of RF signals transferred to the directional coupler, measurement information indicating at least one of a signal power measured at the reverse port or a signal power measured at the forward port to generate a set of measurement values; and
determining information indicating the transmit power based on the set of measurement values.

Aspect 2 is the method according to Aspect 1, wherein the set of frequencies values comprises discrete frequencies values which are distributed within a frequency range and wherein determining the transmit power includes determining the transmit power based on the set of measurement values and at least one predetermined coupling coefficient of the directional coupler.

Aspect 3 is the method according to Aspect 1 or 2, wherein the frequency range spans at least a frequency distance of

$$Δ f = \frac{c}{2 D} ,$$

where c is the RF transmission velocity and D is the distance from the output of the directional coupler to a reflecting structure causing a reflection of the RF signals.

Aspect 4 is the method according to any of the preceding aspects, wherein the output port is coupled to a reflecting structure and outputs for each RF signal an output signal to the reflecting structure, wherein the reflecting structure reflects a portion of each respective output signal as a respective reflection signal back to the output port, wherein each reflection signal comprises at the output port a respective phase value of a set of phase values, wherein the frequency values are selected such that the phase values of the set of phase values are distributed within a phase range.

Aspect 5 is the method according to Aspect 3 or 4, wherein the reflecting structure causing a reflection of the RF signals is a chip solder pad not connected to a PCB or a reflecting structure in a semiconductor package of the RF transmitter or structure in an antenna feed.

Aspect 6 is the method according to any of the preceding aspects, wherein the set of measurement values comprises a first set of first measurement values and a second set of second measurement values, wherein each first measurement value of the first set of first measurement values indicates a measured signal power value at the reverse port for a respective RF signal of the set of RF signals and wherein each second measurement value of the second set of second measurement values indicates a measured signal power value at the forward port for a respective RF signal of the set of RF signals.

Aspect 7 is the method according to Aspect 6, further comprising averaging the first set of first measurement values to generate a first average value and determining the transmit power based on the first average value and at least one coupling coefficient of the directional coupler.

Aspect 8 is the method according to Aspect 7, further comprising averaging the first set of first measurement values to generate a first average value and averaging the second set of second measurement values to generate a second average value; and
determining information indicating the transmit power based on the first average value, the second average value and at least one coupling coefficient of the directional coupler.

Aspect 9 is the method according to Aspect 8, wherein determining information indicating the transmit power is based on calculating a value in accordance with the formula (A²_{fwd,avg} d²−A²_{rev,avg})d²/(d⁴−1) where A²_{fwd,avg} corresponds to the second average value, A²_{rev,avg} corresponds to the first average value and d is a directivity coefficient.

Aspect 10 is the method according to any of the previous aspects, further comprising at least one of:
determining a correction value corresponding to a value measured at the forward port,
determining a correction value corresponding to a value measured at the reverse port.

Aspect 11 is the method according to any of the preceding aspects, wherein the set of frequencies includes at least four different frequency values.

Aspect 12 is a semiconductor device comprising:
a semiconductor chip, the semiconductor chip including at least on RF transmitter;
a directional coupler coupled to the RF transmitter, wherein the directional coupler comprises an input port to receive an RF signal from the RF transmitter, an output port, a forward port and a reverse port, wherein the directional coupler is configured to couple to the forward port a first portion of a signal transmitting from the input port to the output port and wherein the directional coupler is configured to couple to the reverse port a second portion of a signal transmitting from the output port to the input port;
a controller configured to control the RF transmitter to generate a set of RF signals, each RF signal having a frequency value from a set of frequency values;
a detector configured to determine, for each RF signal of the set of RF signals transferred to the directional coupler, first measurement information indicating at least one of a signal power measured at the reverse port or a signal power measured at the forward port to generate a set of measurement values and to determine a transmit power of the RF transmitter based on the set of measurement values.

Aspect 13 is the semiconductor device according to Aspect 12, wherein the controller is configured to control the RF transmitter to generate a set of RF signals, each RF signal having a frequency value from a set of frequency values which are distributed within a frequency range.

Aspect 14 is the semiconductor device according to Aspect 13, wherein the frequency range spans at least a frequency distance of

$$Δ f = \frac{c}{2 D} ,$$

where c is the RF transmission velocity and D is the distance from the output of the directional coupler to a reflecting structure causing a reflection of the RF signals.

Aspect 15 is the semiconductor device according to Aspect 14, wherein the structure causing a reflection of the RF signals is a chip solder pad or a reflecting structure in the semiconductor package or structure in an antenna feed.

Aspect 16 is the semiconductor device according to any of aspects 12 to 15, wherein the set of measurement values comprises a first set of first measurement values and a second set of second measurement values, wherein each first measurement value of the first set of first measurement values indicates a measured signal power value at the reverse port for a respective RF signal of the set of RF signals and wherein each second measurement value of the second set of second measurement values indicates a measured signal power value at the forward port for a respective RF signal of the set of RF signals.

Aspect 17 is the semiconductor device according to Aspect 16, wherein the detector is further configured to average at least one of the first set of first measurement values or the second set of second measurement values.

Aspect 18 is the semiconductor device according to Aspect 16 or 17, wherein the detector is further configured to average the first set of first measurement values to generate a first average value and average the second set of second measurement values to generate a second average value and to determine the transmit power based on the first average value, the second average value and at least one coupling coefficient of the directional coupler.

Aspect 19 is the semiconductor device according to Aspect 18, wherein determining the transmit power is based on calculating a value in accordance with the formula (A²_{fwd,avg} d²−A²_{rev,avg})d²/(d⁴−1) where A²_{fwd,avg} corresponds to the second average value, A²_{rev,avg} corresponds to the first average value and d is a directivity coefficient.

Aspect 20 is the semiconductor device according to any of aspects 12 to 19, wherein the detector is further configured to determine at least one of:
a correction value corresponding to a measurement value associated with the forward port,
a correction value corresponding to a measurement value associated with the reverse port.

Aspect 21 is the semiconductor device according to any of aspects 12 to 20, wherein the detector comprises a power level detector and a processor.

Although specific aspects have been illustrated and described herein, it will be appreciated by those of ordinary skill in the art that a variety of alternate and/or equivalent implementations may be substituted for the specific aspects shown and described without departing from the scope of the present implementation. This application is intended to cover any adaptations or variations of the specific aspects discussed herein. Therefore, it is intended that this implementation be limited only by the claims and the equivalents thereof.

It should be noted that the methods and devices including its preferred implementations as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the implementation and are included within its spirit and scope. Furthermore, all aspects and implementations outlined in the present document are principally intended expressly to be only for explanatory purposes to help the reader in understanding the principles of the proposed methods and systems. Furthermore, all statements herein providing principles, aspects, and implementations of the implementation, as well as specific aspects thereof, are intended to encompass equivalents thereof.

1. A method for determining information indicating a radio frequency (RF) transmit power associated with a RF transmitter, the method comprising:
controlling the RF transmitter to generate a set of RF signals, each RF signal having a frequency value from a set of frequency values;
transferring each RF signal of the set of RF signals to an input port of a directional coupler, the direction coupler comprising in addition to the input port, an output port, a forward port and a reverse port, wherein the directional coupler is configured to couple to the forward port a first portion of a signal received at the input port and wherein the directional coupler is configured to couple to the reverse port a second portion of a signal received the output port;
determining, for each RF signal of the set of RF signals transferred to the directional coupler, measurement information indicating at least one of a signal power measured at the reverse port or a signal power measured at the forward port to generate a set of measurement values; and
determining information indicating the RF transmit power based on the set of measurement values.

2. The method according to claim 1,
wherein the set of frequencies values comprises discrete frequencies values which are distributed within a frequency range, and
wherein determining the RF transmit power includes determining the RF transmit power based on the set of measurement values and at least one predetermined coupling coefficient of the directional coupler.

3. The method according to claim 2, wherein the frequency range spans at least a frequency distance of
$$Δ f = \frac{c}{2 D} ,$$
where c is an RF transmission velocity and D is a distance from the output port of the directional coupler to a reflecting structure causing a reflection of the RF signals.

4. The method according to claim 1,
wherein the output port is coupled to a reflecting structure and outputs for each RF signal an output signal to the reflecting structure,
wherein the reflecting structure reflects a portion of each respective output signal as a respective reflection signal back to the output port,
wherein each reflection signal comprises at the output port a respective phase value of a set of phase values, and
wherein the set of frequency values are selected such that the phase values of the set of phase values are distributed within a phase range.

5. The method according to claim 3, wherein the reflecting structure causing a reflection of the RF signals is a chip solder pad not connected to a PCB or a reflecting structure in a semiconductor package of the RF transmitter or structure in an antenna feed.

6. The method according to claim 1,
wherein the set of measurement values comprises a first set of first measurement values and a second set of second measurement values, and
wherein each first measurement value of the first set of first measurement values indicates a measured signal power value at the reverse port for a respective RF signal of the set of RF signals and wherein each second measurement value of the second set of second measurement values indicates a measured signal power value at the forward port for a respective RF signal of the set of RF signals.

7. The method according to claim 6, further comprising;
averaging the first set of first measurement values to generate a first average value; and
determining the RF transmit power based on the first average value and at least one coupling coefficient of the directional coupler.

8. The method according to claim 7, further comprising;
averaging the first set of first measurement values to generate a first average value and averaging the second set of second measurement values to generate a second average value; and
determining information indicating the RF transmit power based on the first average value, the second average value and at least one coupling coefficient of the directional coupler.

9. The method according to claim 8, wherein determining information indicating the RF transmit power is based on calculating a value in accordance with a formula (A²_{fwd,avg} d²−A²_{rev,avg})d²/(d⁴−1) where A²_{fwd,avg} corresponds to the second average value, A²_{rev,avg} corresponds to the first average value and d is a directivity coefficient.

10. The method according to claim 1, further comprising at least one of:
determining a correction value corresponding to a value measured at the forward port, or
determining a correction value corresponding to a value measured at the reverse port.

11. The method according to claim 1, wherein the set of frequencies includes at least four different frequency values.

12. A semiconductor device comprising:
a semiconductor chip, the semiconductor chip including a radio frequency (RF) transmitter;
a directional coupler coupled to the RF transmitter,
wherein the directional coupler comprises an input port to receive an RF signal from the RF transmitter, an output port, a forward port and a reverse port,
wherein the directional coupler is configured to couple to the forward port a first portion of a signal transmitting from the input port to the output port, and
wherein the directional coupler is configured to couple to the reverse port a second portion of a signal transmitting from the output port to the input port;
a controller configured to control the RF transmitter to generate a set of RF signals, each RF signal having a frequency value from a set of frequency values; and
a detector configured to determine, for each RF signal of the set of RF signals transferred to the directional coupler, first measurement information indicating at least one of a signal power measured at the reverse port or a signal power measured at the forward port to generate a set of measurement values and to determine a transmit power of the RF transmitter based on the set of measurement values.

13. The semiconductor device according to claim 12, wherein the controller is configured to control the RF transmitter to generate a set of RF signals, each RF signal having a frequency value from a set of frequency values which are distributed within a frequency range.

14. The semiconductor device according to claim 13, wherein the frequency range spans at least a frequency distance of
$$Δ f = \frac{c}{2 D} ,$$
where c is a RF transmission velocity and D is a distance from the output port of the directional coupler to a reflecting structure causing a reflection of the RF signals.

15. The semiconductor device according to claim 14, wherein the reflecting structure causing a reflection of the RF signals is a chip solder pad or a reflecting structure in a semiconductor package of the RF transmitter or structure in an antenna feed.

16. The semiconductor device according to claim 12,
wherein the set of measurement values comprises a first set of first measurement values and a second set of second measurement values,
wherein each first measurement value of the first set of first measurement values indicates a measured signal power value at the reverse port for a respective RF signal of the set of RF signals, and
wherein each second measurement value of the second set of second measurement values indicates a measured signal power value at the forward port for a respective RF signal of the set of RF signals.

17. The semiconductor device according to claim 16, wherein the detector is further configured to average at least one of the first set of first measurement values or the second set of second measurement values.

18. The semiconductor device according to claim 16, wherein the detector is further configured to average the first set of first measurement values to generate a first average value and average the second set of second measurement values to generate a second average value and to determine the transmit power based on the first average value, the second average value and at least one coupling coefficient of the directional coupler.

19. The semiconductor device according to claim 18, wherein determining the transmit power is based on calculating a value in accordance with a formula (A2fwd,avg d2−A2rev,avg)d2/(d4−1) where A2fwd,avg corresponds to the second average value, A2rev,avg corresponds to the first average value, and d is a directivity coefficient.

20. The semiconductor device according to claim 12, wherein the detector is further configured to determine at least one of:
a correction value corresponding to a measurement value associated with the forward port, and
a correction value corresponding to a measurement value associated with the reverse port.

21. The semiconductor device according to claim 12, wherein the detector comprises a power level detector and a processor.
